(19) United States
(12) Patent Application Publication
(10) Pub. No.: US 2015/0067492 A1
(43) Pub. Date: Mar. 5, 2015

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventors: Eriko Ozaki, Hachioji-shi (JP); Makoto Hirota, Tokyo (JP); Shinya Takeichi, Kawasaki-shi (JP); Yasuo Okutani, Kawasaki-shi (JP); Hiromi Omi, Kamakura-shi (JP)

(21) Appl. No.: 14/465,259

(22) Filed: Aug. 21, 2014

(30) Foreign Application Priority Data
Aug. 28, 2013 (JP) 2013-176289

(51) Int. Cl. G06F 17/24; G06F 17/27

(52) U.S. Cl. CPC G06F 17/24; G06F 17/276
USPC 715/271

(57) ABSTRACT

An information processing apparatus for representing at least one candidate for a character string to be input based on at least one input character includes an acquisition unit configured to obtain situation information which represents the situation in which the information processing apparatus exists based on the information detected by the at least one sensor. The information processing apparatus further includes a prediction unit configured to predict at least one character string to be input based on the at least one character input by a user operation, a storage unit configured to store two or more character strings with each of the two or more character strings being associated with situation information which represents the situation in which the character string is used and a representation unit configured to represent at least one character string predicted by the prediction unit.

### BACKGROUND OF THE INVENTION

1. Field of the Invention

The present invention relates to a technology for character input performed to a personal computer, a cellular phone etc.

2. Description of the Related Art

A technology for predicting a character string when a user performs a character input in a personal computer, a cellular phone, etc., is known in the art. In the technology, after some characters have been input, the character(s) to be input is predicted. In this technology, the predicted character string(s) is presented as an input candidate (also referred as a conversion candidate). If the presented input candidate is acceptable, the user chooses the input candidate. Therefore, it becomes unnecessary for a user to input all the characters that constitute a text, and the user can efficiently draft the text.

However, in a prediction performed when some characters have been input, a meaningless input candidate, which merely contains only the input character, may be predicted. As a result, in this case, there remains a problem that the input candidate desired by the user is not presented appropriately. In order to overcome this problem, for example, a method for representing input candidates in an order defined according to the frequency (adoption frequency) of selection of the input candidate in the past is known. Further, a method for presenting input candidates based on the detection result of various sensors is known in the art.

In addition, for this problem, a character input apparatus described in Japanese Patent Laid-open No. 2007-193455 is known. In this character input apparatus, when a predetermined word correlating to a sensor is included in an input candidate, the data (detection result) obtained from the sensor is displayed as one of the input candidates. For example, when a word “place” exists in an input candidate, the name of the place of the current position detected by a GPS (Global Positioning System) sensor is displayed.

However, there are following problems in a character input apparatus described in Japanese Patent Laid-open No. 2007-193455. That is, in order to display a result of a detection by a sensor as an input candidate, a predetermined word, which is previously assigned for each sensor, should be contained in an input candidate searched from a dictionary database. For example, to predict, based on the detection result of the sensor, a specific name of a place as an input candidate, the user should not input the name of the interested place itself, rather, the user should input “place”, “present location” etc. Therefore, the user is urged to perform an unnatural character input.

Moreover, as to this case, there remains a problem, i.e., the user should remember the predetermined word to be input for obtaining the detection result of a GPS sensor, such as “place” and “present location”.

### SUMMARY OF THE INVENTION

According to one aspect of the present disclosure, there is provided an apparatus for representing an input candidate suitable for the situation upon which the user performs a character input.

According to an aspect of the present disclosure, an information processing apparatus for representing at least one candidate for a character string to be input based on at least one input character includes an acquisition unit configured to obtain situation information which represents the situation in which the information processing apparatus exists based on the information detected by the at least one sensor, a prediction unit configured to predict at least one character string to be input based on the at least one character input by a user operation, a storage unit configured to store two or more character strings with each of the two or more character strings being associated with situation information which represents the situation in which the character string is used, and a representation unit configured to represent at least one character string predicted by the prediction unit. The at least one predicted character string includes at least one of the character string stored in the storage unit, the representation unit preferentially display the character string associated with the situation information which is similar to that obtained by the acquisition unit.

According to an aspect of the present disclosure, it is possible to preferentially display an input candidate which is suited for the situation at the time of user's character input.

Further features of the present invention will become apparent from the following description of exemplary embodiments (with reference to the attached drawings).

### BRIEF DESCRIPTION OF THE DRAWINGS

FIG. 1A is a diagram for an exemplifying hardware configuration of an information processing apparatus, and FIG. 1B is a diagram for an exemplifying functional configuration of an information processing apparatus.

FIG. 2 is a flowchart illustrating an exemplifying processing procedure of an information processing apparatus of the first embodiment.

FIG. 3 is a flowchart illustrating a processing procedure for determining a degree of similarity of an information processing apparatus of the first embodiment.

FIGS. 4A-4C are diagrams illustrating dictionary tables including situation information of the first embodiment.

FIG. 5 is a figure showing an example of the screen displayed on a display section.

FIG. 6 is a flowchart illustrating a processing procedure for associating an input character strings with a detection result of a sensor and registering the input character.

FIG. 7 is a diagram illustrating a dictionary table including situation information of the second embodiment.

FIG. 8 is a schematic diagram for exemplifying a functional configuration of an information processing apparatus of the third embodiment.

FIG. 9 is a flowchart illustrating an exemplifying processing procedure in additionally displaying an input candidate in response to a change of a user situation when the change has occurred.

FIGS. 10A and 10B are diagrams illustrating examples of screens additionally displaying an input candidate.

FIGS. 11A and 11B are diagrams illustrating examples of screens displaying an input candidate.

### DESCRIPTION OF THE EMBODIMENTS

Now, embodiments of the present disclosure are described with reference to the drawings.

### First Embodiment

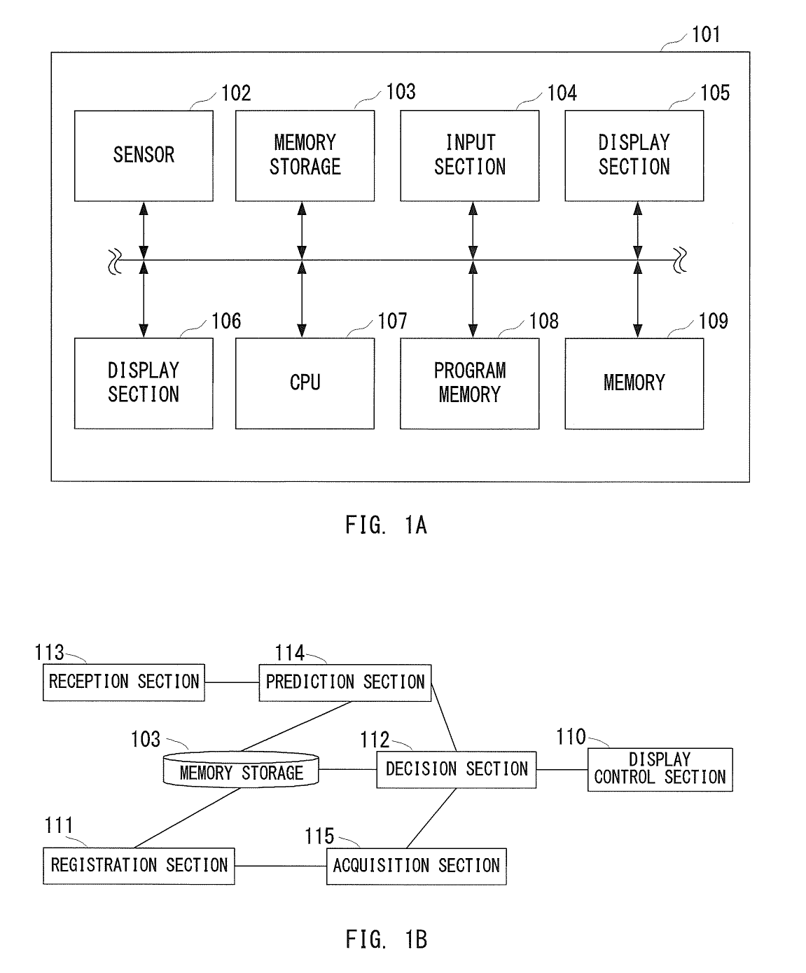

FIG. 1A is a diagram for an exemplifying hardware configuration of an information processing apparatus of the present disclosure, and FIG. 1B is a diagram for an exemplifying functional configuration of an information processing apparatus.

The information processing apparatus 101 illustrated in FIG. 1A includes a sensor 102, a memory storage 103, an input section 104, a communication section 105, a display section 106, a Central Processing Unit (CPU) 107, a program memory 108, and a memory 109.

The sensor 102 is a detection means such as a Global Positioning System (GPS) sensor for detecting the current position of the information processing apparatus 101, an acceleration sensor for detecting acceleration acting on the information processing apparatus 101, and a temperature sensor for detecting ambient temperature, for example. Thus, the sensor 102 detects a variety of information which shows a situation representing the state of the information processing apparatus 101, i.e., the environment in which a user inputting characters exists. In addition, the information processing apparatus 101 may comprise single or a plurality of sensors according to the detection purpose.

In the memory storage 103, information for representing an input candidate (also referred to as “conversion candidate”) for a user is stored as a dictionary. This input candidate is a character string predicted based on some characters input by a user through the input section 104, which receives character input from the user. In addition, the character string, which is to be an input candidate, may contain single or a plurality of words. For example, information about correspondence relation, for predicting “ride” as a corresponding input candidate when a user input “rid”, between “rid” and “ride” and frequency of use of each word is stored in the memory storage 103. In the present embodiment, the dictionary includes a word to which the situation information, which shows situation in which the word is used, is associated. In the present embodiment, the memory storage 103 shall be built in the information processing apparatus 101. However, the memory storage 103 may be an external equipment connected via various networks.

The situation information registered in the dictionary comprises information including the type of the sensor 102 related to the word to be an input candidate, and the sensor value(s) of the sensor 102. Specifically, when the word registered in the dictionary, for example, represents a specific building, the type of the sensor to be related is a GPS sensor. Moreover, the latitude and longitude, which represent the position at which the building exists is recorded as sensor values. Thus, the situation information can represent the situation in which the word is used. Therefore, the word suited for the situation of the user at the time of inputting the character can be represented as an input candidate to the user.

The input section 104 is an input reception means to receive the character input by a user. Moreover, the input section 104 receives the input for designating the word, among the words predicted as input candidate corresponding to the input character string, to be corresponded to the character string. In the present embodiment, a touch panel which can detect the touch input by the user is used as an input section 104. The touch panel overlays the screen of the display section 106, and outputs a signal, in response to a user's touch on the image displayed on the screen, indicating the touched position, to the information processing apparatus 101 to notify the touch. However, pointing devices such as a mouse or a digitizer, or a hardware keyboard may be used in the present embodiment.

The communication section 105 provides mutual communication between the information processing apparatus 105 and external networks such as the Internet, for example. Specifically, the communication section 105 accesses various dictionary databases existing, for example, on a network, receives required information, and transmits the contents input by the user.

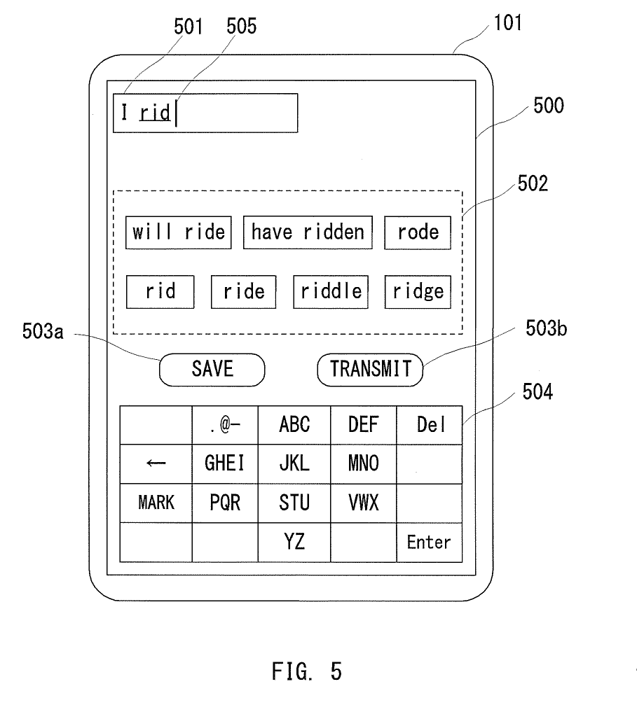

The display section 106 is a liquid crystal display etc., for example, and displays a variety of information on a screen. Moreover, the image displayed on a screen by the display section 106 includes an area (display area 501 described below and in FIG. 5) in which a character string input by the user is displayed, and an area (display area 502 described below and in FIG. 5) in which at least one input candidate is displayed. In the present embodiment, the user inputs characters via touch input to a software keyboard displayed on the display section 106. Therefore, the image displayed on a screen includes an area (the keypad 504 described below and in FIG. 5) in which a software keyboard, which includes various keys for a character input, is displayed.

A CPU 107 controls various sections and units etc., included in the information processing apparatus 101. The program memory 108 is a Read Only Memory (ROM), for example, and the various programs to be executed by the CPU 107 are stored. For example, a memory 109 is a Random Access Memory (RAM) and offers a work area at the time of executing a program by the CPU 107, and temporarily or permanently stores various data required for processing.

Each functional section shown in FIG. 1B is realized by causing the CPU 107 to develop the program stored in the program memory 108 on the memory 109 and to perform the process described in each of the flow charts described below. Moreover, for example, when using hardware in place of software processing using the above-mentioned CPU 107, operation units and/or circuits corresponding to the processing of each functional section explained here are used.

A display control section 110 generates, on the screen of the display section 106, a display image for displaying the input candidate(s) predicted by the prediction section 114, and output to the generated display image to the display section 106. Thereby the display control section 110 controls the displayed contents.

A registration section 111 registers new input candidate in the dictionary stored in the memory storage 103. The new input candidate associates the character string input by the user and the situation information obtained, based on the detection result of a sensor 102, by an acquisition section 115. Moreover, the registration section 111 updates the contents of the situation information already registered in the dictionary based on the newest detection result of the sensor 102. The details thereof are described later.

The decision section 112 compares the situation information registered in the dictionary with the situation information obtained by the acquisition section 115 based on the detection result of the sensor 102, thus the decision section 112 obtains degree of similarity and judges whether two situations are similar or not. The details thereof are described later.

The reception section 113 receives the information represented by the signal outputted from the input section 104. Particularly, in the present embodiment, the coordinates which represent the position at which the user touched, or the position at which the user stopped the touch (release position) are obtained from the input section 104, which is a touch panel. The obtained coordinates are treated as a position within the image displayed on the screen of the display section 106 overlaying the touch panel. When a part of a user interface is displayed on the position, the touch is received as an input for designating the part. For example, the touch input in a position at which a key of a software keyboard is displayed is received as a character input of a character corresponding to the key displayed on the touched position.

The prediction section 114 predicts at least one character string constituted by the input characters based on the input character and the information registered in the dictionary, and the predicted character string is treated as a candidate for the character string to be input. In the present embodiment, a candidate corresponding to the situation is determined preferentially and is represented by the display control section 110. This decision is made based on the input received by the reception section 113, the selection frequency in the past selections in which the character string is predicted as a candidate, and the decision result in the decision section 112. For example, the display control section 110 controls the display so that the candidates are ordered by the decreasing degree of similarity to the user's situation. The details thereof are described later.

The acquisition section 115 obtains the situation information representing the situation in which the information processing apparatus 101 exists and notifies the obtained situation information to the decision section 112 and the registration section 111. This situation information is information detected by the sensor 102, such as a position, acceleration, a direction, humidity, atmospheric pressure, etc.

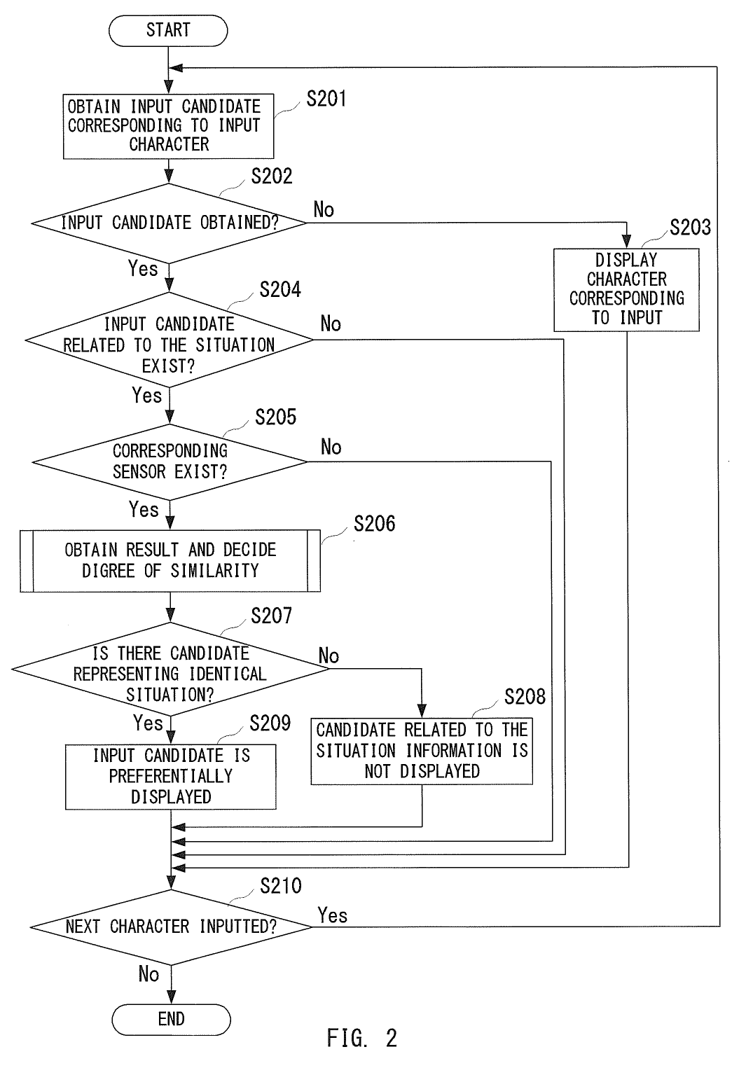

FIG. 2 is a flow chart illustrating a process procedure of the information processing apparatus 101. In the present embodiment, a software keyboard is displayed in response to a call from application, and the flow chart of FIG. 2 is started when the user is allowed to input characters.

As a functional section of the CPU 107, the prediction section 114, predicts, in response to the reception, at the reception section 113, of the character input by the user's touch of the software keyboard, the word corresponding to the input character string based on the registered information in the dictionary stored in the memory storage 103. Further, the predicted word is specified as an input candidate and held (S201).

A decision section 112, which is a functional section of the CPU 107, decides whether the input candidate is specified or not (S202). When it is decided that the input candidate is not specified (S202: No), the character string input by the user is displayed on the screen (S203), and wait for the next character input by a user (S210). When it is decided that the input candidate is specified, (S202: Yes), it is decided whether the input candidate associated with the situation information (for example, GPS information) in the dictionary exists in the input candidate stored in the processing of step S201 or not (S204).

When it is decided that there exists the input candidate associated with the situation information (S204: Yes), the decision section 112, which is a functional section of the CPU 107, decides whether or not the information processing apparatus 101 includes the sensor 102 corresponding to the sensor represented by the situation information of the specified input candidate (S205). For example, the decision section 112 decides whether or not the sensor 102 includes a GPS sensor, a temperature sensor, etc., represented by the situation information. If the sensor represented by the situation information is not included (S204: No), the process goes to step S204.

Further, when the sensor represented by the situation information is included (S204: Yes), the acquisition section 115, which is a functional section of the CPU 107, obtains the present situation as situation information. Then, the decision section 112, which is a functional section of the CPU 107, decides, based on the detection result of the sensor obtained by the acquisition section 115, whether the present situation is similar to the situation associated with the input candidate or not (S206).

When the degree of similarity between the situation (for example, latitude and longitude) represented by the situation information of the input candidate and the situation represented by the detection result (for example, latitude and longitude, which are the detection results of a GPS sensor) is high, it is decided that the both situations are similar. By comparing the degree of similarity with a threshold value set each type of the sensors, the decision section 112 can decide whether both the situations are similar or not. The threshold value is previously stored in the program memory 108, for example.

In addition, when the input candidate is associated with two or more pieces of situation information, the decision is repeatedly performed based on each piece of situation information. Further, in the decision of the size of degree of similarity, it is possible to decide that the both situations are identical when the sensor value represented by the situation information associated with the input candidate and the detection result of the sensor 102 are identical.

Further, it is possible to configure so as to learn whether the situations should be decided to be identical (or similar) or not, based on the selection frequency of the input candidate represented to the user. In case two or more input candidates correspond to the same sensor, the input candidate which is associated with the situation information having highest degree of similarity for the situation detected by the sensor may be decided to be the same situation.

In the following embodiment, two or more situations are decided to be identical (or similar) based on the degree of similarity. In this example, one or more words corresponding to the input character string are displayed on a screen as an input candidate according to the decision result.

The decision section 112, as a functional part of the CPU 107, decides whether there is an input candidate representing the identical situation or not based on the decision result of processing of Step S206 (S207). When the decision section 112 decides that there is the input candidate (S207: Yes), the display control section 110, as a functional part of the CPU 107, generates a display in which the input candidate is preferentially displayed, as compared to the other input candidates, and outputs the image to the display section 106 (S209). Otherwise (S207: No), a display image in which the input candidate related to the situation information is not displayed is generated and outputted to the display section 106 (S208). Therefore, the input candidate decided not to be similar, since the degree of similarity between the present situation (situation at the time of decision for the input candidate) and the situation associated with the input candidate is low, is not displayed. Thereby, an effective display layout on the screen is achieved, for example, and user's visibility is ensured. Instead of not displaying the candidate, it is possible to control the display layout of the candidates on the screen, for example, in an order according to the degree of similarity decided by the decision section 112. Then, reception section 113, which is a functional part of the CPU 107, waits for next character input (S210), and returns to processing of step S201 upon receiving next character input (S210: Yes). For example, in case next character input is not input by the user after a lapse of a predetermined time period is detected by the timer (not illustrated), when it is decided that the character input has been completed (S210: No), this process is ended.

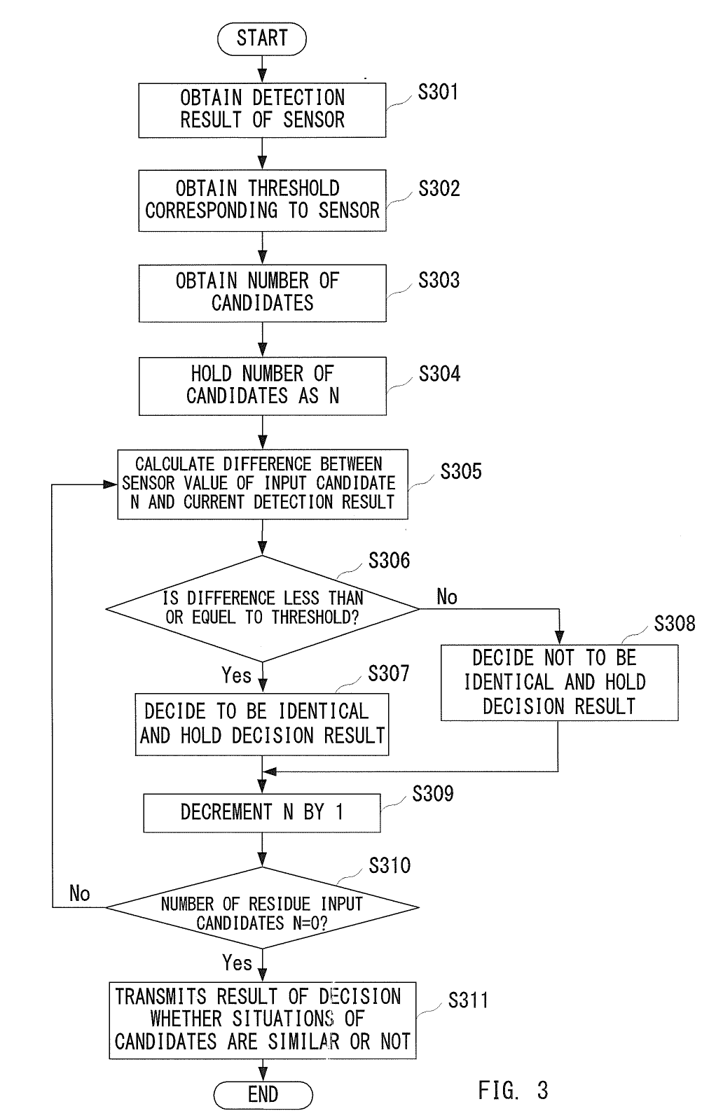

FIG. 3 is an exemplary flow chart illustrating a specific process procedure of the process of step S206 (deciding whether two situations are similar or not) illustrated in FIG. 2

Decision section 112, which is a functional section of the CPU 107, obtains the detection result of the sensor represented in the input candidate's situation information (S301). Then, the threshold corresponding to the sensor is obtained (S302). The threshold is determined based on the distance permitted as an error of measurement, for example in a GPS sensor, and based on the temperature range permitted as an error of measurement in a temperature sensor, etc. Further, it is possible to constitute so as to learn the amount of errors permitted according to a selection frequency of an input candidate represented to the user, and employing the learned result as a threshold. The decision section 112 may hold the threshold; alternatively, memory storage 103 may store the same.

The decision section 112, which is a functional section of the CPU 107, obtains the number of the candidates specified in the process of S204 (S303). The obtained number is held as the number of candidates N (S304). Hereinafter, the processes defined in Step S305 to Step S310 are performed to the serially numbered input candidates including the first candidate to the N-th candidate according to the order of the number of the input candidates.

Decision section 112, which is a functional section of the CPU 107, calculates the difference between the sensor value of the situation information of the specified input candidate and the detection result obtained in step S301 (S305). Then, decision section 112 decides whether the computed difference is less than or equal to the threshold obtained by the process of step S302 (S306). If it is decided that the difference is less than or equal to the threshold (S306: Yes), the present input candidate is decided to be identical (or similar) to the obtained detection result, and holds the decision result (S307). Otherwise (S306: No), the present input candidate is decided not to be identical (or similar) to the obtained detection result, and holds the decision result (S308). In case the present input candidate is decided not to be identical (or similar) to the obtained detection result, the decision result may not be held.

The decision section 112, which is a functional section of the CPU 107, decrements the number N of the input candidate by 1, thereby the number will be N−1 (S309). Then, it is decided that whether the number N of the input candidate is 0 or not (S310). If the number N is not 0 (S310: No), the process returns to the step S305. If the number N is 0 (S310: Yes), the process proceeds to the step S311.

The decision section 112, as a functional part of the CPU 107, transmits the result of the decision whether the two situations are similar or not based on the degree of similarity of the situations (S311). This decision is performed based on the decision result held in the step S307. Thus, a series of processes is completed.

In addition, the sensor value of the situation information may be registered with combining the sensor values of two or more different types of sensors, or registered with combining the sensor values of two or more identical type of sensors. The process procedure in this case is explained using the flow chart illustrated in FIG. 2 (each process from Step 201 to Step 210), and FIG. 3 (each process from Step S301 to Step S311).

In this case, it is decided that there is an input candidate which is associated with the situation information comprising two or more sensor values in combination in the process of Step S204 illustrated in FIG. 2. In this case, in the process of step S205, it is decided whether all the sensors represented by the situation information is included in the information processing apparatus 101. Then, in the process of step S206, the detection result of sensor 102 corresponding to the sensor represented by the situation information is obtained one by one. Alternatively, it is possible to select the detection result of only the sensor 102 included in the information processing apparatus 101, among the sensors represented by the situation information for deciding whether the situation is identical or not.

In the process of step S301 illustrated in FIG. 3, the detection result of each sensors is obtained. In the process of step S302, the threshold for each type of sensor, or the threshold corresponding to the combination of the sensor value is obtained.

In the former case, it is decided that whether the situations are identical or not, based on the predetermined standard such as “all the values are less than or equal to the threshold or not”, or “at least one value is less than or equal to the threshold or not”. For example, assuming that a GPS sensor and an atmospheric pressure sensor are registered as sensor types. In this case, as to the following first and second detection results, it is decided that whether both of the two detection results are within the threshold or not. It is noted the first detection result is the detection result of the position information, which is the detection result of the GPS sensor, and the second detection result is the detection result of the atmospheric pressure information, which is the detection result of the atmospheric pressure sensor. Further, it is decided that whether the situations are identical or not, based on the decision of the two detection results.

Even if when the position information is decided to be in identical situation, for example, it is possible to represent the input candidate suitable for the user's situation. This is achieved by using, for example, the difference in the atmospheric pressure, deciding that the user is in the first floor of a building or in the highest floor of the same.

On the other hand, in the latter case, as to the difference between the values of the two pieces of the situation information, it is decided that whether the difference is less than or equal to the threshold. In this case, one value is the value represented by the situation information which is defined by the combination of the sensor value, and another value is the value represented by the detection result detected by the corresponding sensor 102. Further, it is decided that the situations are identical (or similar) or not, based on the decision of the difference between the values.

For example, an embodiment in which the types of the situation information is a GPS sensor, an acceleration sensor, and a geomagnetism sensor, and the sensor values are registered in combination each other is explained below. It is noted that, in the following embodiment, the acceleration information, which is a sensor value of situation information, represents transition of the acceleration in the situation in which the user is moving by train, or represents the situation in which the user is moving on foot. In this case, it is decided that whether the situations of user's movement (for example, move by train, move on foot) are similar or not by using the degree of similarity of transition of acceleration detected by the acceleration sensor, which is sensor 102. By using the detection results of an acceleration sensor and a geomagnetism sensor, the direction which represents the direction to which the user is moving is estimated.

In such a case, when deciding whether the situations are similar or not based on the degree of similarity, at first, it is decided that whether the situation represents user's movement by train or user's movement on foot based on transition of acceleration. Thus, the number of words to be decided is decreased. Next, if the situation is decided to be movement by train, based on the detection result of the GPS sensor which is sensor 102, the area along the railroad line of the train under movement is specified. Further, based on the detection result of each of the acceleration sensor, which is sensor 102, and a geomagnetism sensor, the direction of movement is estimated. Thus, by controlling the decision process based on the degree of similarity, the input candidate which is more suited for the user's situation is represented.

In addition, even if the degree of similarity based on the detection result of at least a part of sensors 102 is high, i.e., the situations are decided to be similar, in some cases, the degree of similarity based on the detection result of other types of sensors 102 may be low. Therefore, it is necessary to decide each degree of similarity totally. Thus, when the degree of similarity of the situation is decided based on the detection result of at least two different types of sensors 102, an important sensor type and a weight value for each sensor value of the situation information are previously defined. The decision for the degree of similarity is performed based at least a part on this defined weight value.

In each process of step S303 and step S304, the same process as in a case where single sensor type is employed is performed. In the process of step S305, each difference is computed according to the combination of the sensor value of the situation information. In addition, in each process after the process of step 306, the same process as in a case where single sensor type is employed is performed. Thus, even in a case where the situation information is constituted by combining two or more sensor values, it is possible to perform the decision based on the degree of similarity.

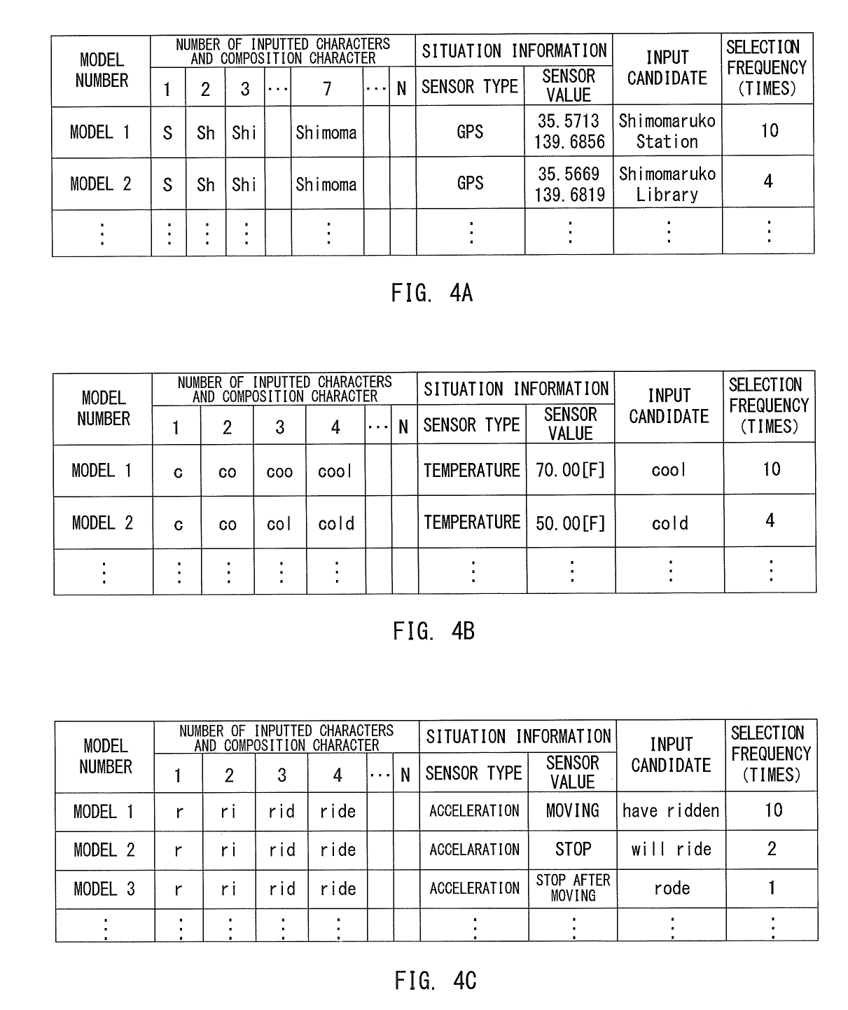

FIG. 4 is a figure illustrating, among the dictionary information stored in the memory storage 103, an example of a dictionary table including the situation information associated with the word. The dictionary tables illustrated in FIG. 4A-4C have each item of a model number, the number of input characters and its composition character(s), situation information, input candidates, and selected frequency.

In models 1 and 2 of the dictionary table illustrated in FIG. 4A, each of “S”, “Sh”, “Shi” and “Shimoma” are the constituting character(s). In both models 1 and 2, when the numbers of input character(s) are “1”, “2”, “3” and “7”, composition characters are “S” “Sh”, “Shi” and “Shimoma”, respectively. When the character string input by the user at the beginning of the same matches the composition characters such as “S”, “Sh”, “Shi”, and “Shimoma”, i.e., right truncation matching, the words of the input candidates corresponding to these composition characters (for example, Shimomaruko Station etc.,) are represented on the screen. The input candidate illustrated in FIG. 4A is the word “Shimomaruko Station” and “Shimomaruko Library”, and each is associated with the situation information. In the situation information of the input candidate “Shimomaruko Station”, sensor type is “GPS (sensor)”, and the latitude and the longitude of the sensor value is “35.5713” and “139.6856”, respectively. Further, in the situation information of the input candidate “Shimomaruko Library”, sensor type is “GPS (sensor)”, and the latitude and the longitude of the sensor value is “35.5669” and “139.6819”, respectively.

In addition, the each of the sensor values (latitude and longitude) registered in the situation information is the average value of the result measured two or more times in order to minimize the influence of the error of measurement. Instead of the average value, the range between the minimum and the maximum values of the sensor may be employed

The selection frequency of the input candidate “Shimomaruko Station” is “10” times, and that of “Shimomaruko Library” is “4” times. Base on the selection frequency, when there are two or more input candidates for the word including the character “S”, “Sh”, “Shi”, and “Shimoma”, the input candidates may be reordered by the decreasing selection frequency and displayed on the screen. In addition, the word of the input candidates may be reordered based on the last used (employed) date or time, or reordered based on the combination of selection frequency and the last used (employed) date or time.

In the prior art, in case where the two input candidates “Shimomaruko Station” and “Shimomaruko Library” are found for the character input of the user “shimoma”, only one input candidate having higher selection frequency is displayed, or giving priority to the last used candidate in displaying the same. For example, as to the selection frequency illustrated in FIG. 4A, the input candidate “Shimomaruko Station” will be displayed as the first candidate.

On the other hand, in the information processing apparatus 101, when the selection frequency of the word represented as an input candidate is low, or even if the word represented as an input candidate is not used lately, it is possible to give priority in displaying the input candidate suited for the situation of the user. For example, it is possible to give priority in displaying the input candidate suited for the situation of the user based on the detection result of the GPS sensor. For example, when the current position representing the user's situation is near the place “Shimomaruko Station”, the input candidate “Shimomaruko Station” is preferentially displayed to the character input of “Shimoma”. If the current position is near a library, the input candidate “Shimomaruko Library” is preferentially displayed. Hereinafter, the process procedure for performing the above processes is explained in detail with reference to the flow charts illustrated in FIGS. 2 and 3.

In this case, the user inputs “Shi” near Shimomaruko Station. Further, the sensor 102 of the information processing apparatus 101 is a GPS sensor.

In the process of step S201 illustrated in FIG. 2, the input candidate corresponding to the character input “Shi” is obtained from the dictionary of memory storage 103. Suppose that two or more input candidates, such as “ship”, “shield”, and “shirt”, were obtained, for example, for a character input “Shi”. It is noted that the number of input candidates allowed to be displayed may be restricted, depending on the size of the display section 106. In that case, according to the allowed number of the input candidates, for example, only the input candidates having high selection frequency is displayed. Further, regardless of the allowed number of the input candidates, it is also possible to obtain as many input candidates as possible.

In the process of step 202, it is decided that two or more input candidates are obtained. Then, in the process of step S204, it is decided that whether there is an input candidate which is associated with the situation information among the obtained input candidate or not. In case there is no input candidate associated with the situation information among the obtained input candidates “ship” and “shield” and “shirt”, the process waits for next character input from the user in step S210.

Then, in response to the character input of “mo” from the user, in the process of step S201, the input candidate corresponding to “shimo” is again obtained from the dictionary of memory storage 103. Alternatively, when as many input candidates as possible have been obtained in the last process, the input candidate may be obtained again out of them. Then, each process from step S202 to step S204 is performed. In this case, there is no input candidate associated with the situation information among the obtained input candidate.

Further, in response to the character input “ma” from the user, in the process of step S201, the input candidate corresponding to “shimoma” is obtained from the dictionary in the memory storage 103 again. In this case, “shimoma”, “Shimomaruko”, “Shimomaruko Library”, and “Shimomaruko Station” have been obtained as input candidates for the character input “shimoma.”

In step 204, it is decided that whether there is an input candidate which is associated with the situation information among the obtained input candidate, in the process of step S204. As illustrated in FIG. 4A, the input candidate “Shimomaruko Library” and “Shimomaruko Station” are related to the situation information. Therefore, the process goes to the process of step S205. In the process of step S205, it is decided that the information processing apparatus 101 has a GPS sensor. Then, process goes to step S206, and the degree of similarity of the situation is decided.

In the present embodiment, in step S301 illustrated in FIG. 3, the detection result of the GPS sensor is obtained for deciding whether the situations are identical or not. In the situation information of the input candidate “Shimomaruko Station”, sensor type is “GPS (sensor)”, and the latitude and the longitude of the sensor value is “35.571 2” and “139.68 6 1”, respectively.

The threshold corresponding to the GPS sensor is obtained in the process of step S302. Here, the threshold is 500 [m].

In the process of step S303, two input candidates, i.e., “Shimomaruko Library” and “Shimomaruko Station” are specified. Therefore, as to the number N of the input candidates in step 304, it is held as N=2.

In the process of step S305, as to the latitude (35.5669) and longitude (139.6819) which are the sensor values of “Shimomaruko Library” of the input candidate with N=2, and the latitude (35.5712) and longitude (139.6861) which are the detection results of the GPS sensor, the difference between the latitudes and the difference between the longitudes are respectively computed. Here, this difference is computed, for simplification, as a distance between two points on the circumference of the earth. First, in order to find the length of a circle, the difference in latitudes (difference of “35.5712” and “35.5669”) is calculated in radian (i.e. 0.0000750492 rad), and the difference in longitudes (difference of “139.6861” and “139.6819”) is calculated in radian (i.e., 0.0000733038 rad). Then, based on the calculated difference of latitudes in radian and the radius of the earth, the distance along north-south direction is calculated as (0.119129 [km]). Further, based on the latitude, the calculated difference of longitude in radian and the radius of the earth, the distance along east-west direction (0.3803158 [km]) is calculated. Further, the distance between the two points is obtained as 0.611366 [km], by calculating root mean square of the two distance. Therefore, the difference of the distances is decided to be 611 [m].

In the process of step S306, it is decided that whether the obtained difference is less than or equal to a threshold. Since the threshold in this embodiment is 500 [m] and the obtained difference is 611 [m], which exceeds the threshold, therefore, it is noted that the situations are not identical. Then, the process goes to the process of step S309, the number N (=2) of the input candidates is decremented by 1, therefore, N=1.

In the process of step S310, since the number of input candidates N is 1 (N=1), the process returns to the process of step S305, and the difference for the next input candidate is calculated.

In the process of step S305, as to the latitude (35.5713) and longitude (139.6856) which are the sensor values of “Shimomaruko Station” of the input candidate with N=1, and the latitude (35.5712) and longitude (139.6861) which are the detection results of the GPS sensor, the difference between the latitudes and the difference between the longitudes are respectively computed. As a result, the distance between the two points is calculated to be 0.004662 [km], and the difference 46 [m] is obtained.

In the process of step S306, it is decided that whether the obtained difference is less than or equal to a threshold. Since the threshold is 500 [m] and the obtained difference is 46 [m], which does not exceed the threshold, it is decided that the situations are identical, and the decision result is held. Then, the process goes to the process of step S309, the number N (=1) of the input candidates is decremented by 1, therefore, N=0, and the process goes to the process of step S311. In the process of step S311, as to the input candidate “Shimomaruko Station”, the decision result indicating that the situations are identical is outputted, and as to the input candidate “Shimomaruko Library”, the decision result which shows that the situations are not identical is outputted.

The process returns to the process of step S206 illustrated in FIG. 2, and it is decided that there is an input candidate which represents identical situation in the process of the following step S207, and the input candidate “Shimomaruko Station” is given priority in displaying in the process of step S209. Then, the process waits for the next character input by the user in the process of step S210.

Alternatively, it is possible to obtain the difference between the distances based simply on the difference between the latitudes and the difference between the longitudes, and decides whether the difference is less than or equal to the threshold or not. Further, as a calculation method for obtaining the distance between two points, it is possible to employ a calculation method which calculates the length of arc between the two points, considering that the earth is spherical. Further, it is possible to employ a calculation method in which the earth is modeled as an ellipsoid. Thus, various calculation methods which can calculate the distance for two points may be selected and used. The variety of information required for a calculation process may be previously stored, for example in the program memory 108, or held by the decision section 112. Further, the calculation process may be performed on a network, and various types of information required for the calculation may be updated. Further, it is possible to obtain the detection result of the sensor for each calculation process, and/or the calculation processes related to different types of sensors may be performed simultaneously.

Further, as to display of the input candidates, it is possible to display only the input candidate which is associated with the situation information regardless of selection frequency. In addition, it is possible to display the input candidates with high selection frequency in an extra window, or to display the input candidates based on the sum of the weights which are given each element consisting the situation information.

As to FIG. 4B, the model 1 of the dictionary table illustrated in FIG. 4B, each of “c”, “co”, “coo” and “cool” are the constituting character(s). In the model 1, when the numbers of input character(s) are “1”, “2”, “3” and “4”, composition characters are “c” “co”, “coo” and “cool”, respectively. The model 2 of the dictionary table illustrated in FIG. 4B, each of “c”, “co”, “col” and “cold” are the constituting character(s). In the model 2, when the numbers of input character(s) are “1”, “2”, “3” and “4”, composition characters are “c” “co”, “col” and “cold”, respectively.

The input candidate illustrated in FIG. 4B is the word “cool” and “cold”, and each is related with the situation information. As to the situation information of the input candidate “cool”, the sensor type is “temperature (sensor)” and the sensor value is “70.00 [F]”. As to the situation information of the input candidate “cold”, the sensor type is “temperature” and the sensor value is “50.00 [F]”. The selection frequency of the input candidate “cool” is “10” times, and that of “cold” is “4” times.

For example, consider the case in which the user input a character “c”, and the sensor 102 of the information processing apparatus 101 is temperature sensor. In this case, corresponding to the character input “c”, if the detection result of the temperature sensor is about 70 [F], “cool” will be preferentially represented as an input candidate. If the detection result is about 50 [F], “cold” will be preferentially represented as an input candidate. Hereinafter, the process procedure for performing the above processes is explained with reference to the flow charts illustrated in FIGS. 2 and 3.

Here, consider the case in which the user input a character “c” under the situation where the atmospheric temperature (temperature) is 65 [F].

In the process of step S201 illustrated in FIG. 2, the input candidate corresponding to the character input “c” is obtained from the dictionary of memory storage 103. Suppose that “call”, “called”, “certain”, “cool”, “cold”, etc. were obtained as a higher rank candidate, for example to an input character “c.”

Suppose that two or more input candidates were obtained. Then, in the process of step S204, it is decided that whether there is an input candidate which is associated with the situation information among the obtained input candidate or not. As illustrated in FIG. 4B, the input candidates “cool” and “cold” are associated with the situation information. Therefore, the process goes to the process of step S205. In the process of step S205, it is decided that the information processing apparatus 101 has a temperature sensor. Then, process goes to step S206, and the degree of similarity of the situation is decided.

In the present embodiment, in step S301 illustrated in FIG. 3, the detection result of the temperature sensor is obtained for deciding whether the situations are identical or not. Here, suppose that the detection result of the temperature sensor is 65.00 [F].

The threshold corresponding to the temperature sensor is obtained in the process of step S302. Here, the threshold is 6 [F].

In the process of step S303, two input candidates “cool” and “cold” are specified. Therefore, as to the number N of the input candidates in step 304, it is held as N=2.

In the process of step S305, the difference of the temperature (50.00) which is a sensor value of “cold” of the input candidate with N=2, and the temperature (65.00) which is the present detection result of the temperature sensor obtained by the process of step S301 is calculated. As a result, the difference 15 [F] is obtained.

In the process of step S306, it is decided that whether the obtained difference is less than or equal to a threshold. Since the threshold is 6 [F] and the difference is 15 [F], it is decided that the situations are not identical. Then, the process goes to the process of step S309, the number N (=2) of the input candidates is decremented by 1, therefore, N=1.

In the process of step S310, since the number of input candidates N is 1 (N=1), the process returns to the process of step S305, and the difference for the next input candidate is calculated.

In the process of step S305, the difference of the temperature (70.00) which is a sensor value of “cool” of the input candidate with N=1, and the temperature (65.00) which is the present detection result of the temperature sensor obtained by the process of step S301 is calculated. As a result, the difference 5 [F] is obtained. In the process of step S306, it is decided that whether the obtained difference is less than or equal to a threshold. Since the threshold is 6 [F] and the obtained difference is 5 [F], it is decided that the situations are identical, and the decision result is held. Then, the process goes to the process of step S309, the number N (=1) of the input candidates is decremented by 1, therefore, N=0, and the process goes to the process of step S311. In the process of step S311, the decision result, which shows that the input candidate “cool” is in an identical situation and the input candidate “cold” is not in an identical situation, is outputted.

The process returns to the process of step S206 illustrated in FIG. 2, and it is decided that there is an input candidate which represents identical situation in the process of the following step S207, and the input candidate “cool” is given priority in displaying in the process of step S209. Then, the process waits for the next character input by the user in the process of step S210.

In models 1 and 2 of the dictionary table illustrated in FIG. 4C, each of “r”, “ri”, “rid” and “ride” is the constituting character(s). In both models 1 and 2, when the numbers of input character(s) are “1”, “2”, “3” and “4”, composition characters are “r” “ri”, “rid” and “ride”, respectively.

The input candidates illustrated in FIG. 4C are verbs each having different tenses, such as “have ridden”, “will ride”, and “rode”, and each tense is associated with situation information. As to the situation information of the input candidate “have ridden”, the sensor type is “acceleration”, and the sensor value is “moving”. As to the situation information of the input candidate “will ride”, the sensor type is “acceleration”, and the sensor value is “stop”. As to the situation information of the input candidate “rode”, the sensor type is “acceleration”, and the sensor value is “stop after moving”. The selection frequency of the input candidate “have ridden” is “10” times, that of the input candidate “will ride” is “2” times, and that of the input candidate “rode” is “1” time.

The sensor value illustrated in FIG. 4C is the result of estimation of the user's situation based on the detection result of the acceleration sensor, and “moving” is stored as the sensor value of model 1, and “stop” is stored as the sensor value model 2 with the sensor value of model 1. Specifically, based on the detection results of the acceleration sensor during predetermined period (for example, 1 second), it is possible to calculate the value of variance, and to decide whether the detection result represents “stop” or “moving” according to the calculated value of variance. In addition, according to the transition of acceleration detected by the acceleration sensor, which is sensor 102, it is possible to decide whether the user is in the situation which is moving on foot”, or “the situation which is running and moving.” Further, it is possible to decide that the detection result represents “having stopped after moving” or “after moving by vehicle, changed to move on foot”. For example, the above decision is achieved by deciding the status of the situation at a predetermined interval, and by storing and referring to the information which represents “stop” or “moving” and the information which represents the degree of speed of the movement.

In addition, like the case where the detection result is acceleration, when the detection result is speed, or the amount of displacement, converting it to as a sensor value which represents the user's situation, then, it is recorded in the situation information.

For example, suppose that the user input the character “rid”. Further, suppose that the sensor 102 of the information processing apparatus 101 is an acceleration sensor. In this case, as to the character input “rid”, if the user is in the situation of moving, the input candidate “have ridden” is displayed preferentially, and if the user is in the situation of having stopped, the input candidate “will ride” is displayed preferentially. Hereinafter, the process procedure for performing the above processes is explained with reference to the flow charts illustrated in FIGS. 2 and 3.

Here, suppose that the character “rid” is input under the situation where the user is moving.

In the process of step S201 illustrated in FIG. 2, the input candidate corresponding to the character input “rid” is obtained from the dictionary of memory storage 103. Suppose that “rid”, “ride”, “riddle”, “ridge”, “will ride”, “have ridden”, etc., are obtained as a higher rank input candidate, for example, to the character input “rid.”

In the process of step 202, it is decided that two or more input candidates are obtained.

Then, in the process of step S204, it is decided that whether there is an input candidate which is associated with the situation information among the obtained input candidate or not. As illustrated in FIG. 4C, an input candidate “have ridden” and “will ride” are related with the situation information. Therefore, the process goes to the process of step S205. In the process of step S205, it is decided that the information processing apparatus 101 has a temperature sensor. Then, process goes to step S206, and the degree of similarity of the situation is decided.

In the present embodiment, in step S301 illustrated in FIG. 3, the detection result of the acceleration sensor during last 1 minute is obtained for deciding whether the situations are identical or not. Here, since the user is moving, the situation of the user is estimated to be “moving” based on a detection result.

The threshold corresponding to the acceleration sensor is obtained in the process of step S302. Here, the threshold is 0. This is for estimating a user's situation based on the detection result of an acceleration sensor, and deciding whether the estimated situation is identical to the situation represented by the input candidate. In the process of step S303, two input candidates, i.e., “have ridden” and “will ride” are specified. Therefore, as to the number N of the input candidates in step 304, it is held as N=2.

In the process of step S306, “stop”, which is a sensor value of “will ride” of the input candidate with N=2, and “moving”, which is estimated from the detection result obtained by the process of step S301 are compared. As a result, it is decided that the situations are not identical. Then, the process goes to the process of step S309, the number N (=2) of the input candidates is decremented by 1, therefore, N=1. In the process of step S310, since the number of input candidates N is 1 (N=1), the process returns to the process of step S305, and a comparison with the next input candidate is performed.

In the process of step S306, “have ridden”, which is a sensor value of “moving” of the input candidate with N=1, and “moving”, which is estimated from the detection result obtained by the process of step S301 are compared. As a result, it is decided that the situations are identical, and the decision result is held. Then, the process goes to the process of step S309, the number N (=1) of the input candidates is decremented by 1, therefore, N=0, and the process goes to the process of step S311. In the process of step S311, the decision result, which shows that the input candidate “have ridden” is in an identical situation and the input candidate “will ride” is not in an identical situation, is outputted.

The process returns to the process of step S206 illustrated in FIG. 2, and it is decided that there is an input candidate which represents identical situation in the process of the following step S207, and the input candidate “have ridden” is given priority in displaying in the process of step S209. Then, the process waits for the next character input in the process of step S210.

FIG. 5 is a figure showing an example of the screen displayed on a display section 106. Here, suppose that, in the information processing apparatus 101 illustrated in FIG. 5, an e-mail application has been started, and the user is inputting characters for writing an e-mail.

A screen 500 illustrated in FIG. 5 includes a display area 501 where the character which the user input is displayed, a display area 502 where input candidates are displayed, and the area where a keypad 504, which is an example of input apparatus, is displayed. In the screen 500, a save button 503a for directing preservation of the mail created by the user and a transmission button 503b for directing transmission of the created mail are arranged.

In the display area 501, among the characters which have been input to the input position indicated by a cursor 505 by the user, the character “I” has been settled, i.e., character conversion has been completed, and the characters “rid” has not been settled, i.e., character conversion has not been completed and waiting for selection of the input candidate.

In response to the characters “rid” input by the user, the input candidates “rid”, “ride”, “ridge”, “riddle”, “have ridden”, and “rode” is displayed on the display area 502, and the input candidate “will ride” is preferentially displayed. In this embodiment, “preferentially displayed” means, for example, that the input candidate which is preferentially displayed is displayed at a default cursor position at which a selection cursor (not illustrated) for selecting input candidate is initially displayed on the screen 500. Specifically, the input candidate may preferentially displayed at an upper-left position in the display area 502 viewed from front view.

In the dictionary table illustrated in FIG. 4C, as to the input character “ride”, the input candidate “will ride” and “have ridden”, to which the situation information are respectively related, is registered. Therefore, when the user inputs characters “ride”, the detection result of the acceleration sensor, which is sensor 102, is obtained, and the user's situation is estimated based on the obtained detection result. If the estimated situation is “stop”, the input candidate “will ride” is preferentially displayed as compared to other input candidates (“rid”, “ridge”, “have ridden”, “ride”), as illustrated in FIG. 5, specifically, the situation “stop” is the situation in which the user is waiting for arrival of a train, for example.

In case where the user have been ridden on a train, the situation is estimated to be “moving”, therefore, the input candidate “have ridden” is preferentially displayed, as compared to other input candidates.

Hereinafter, registration of various types of information, by registration section 111, to the dictionary information stored in the memory storage 103 is explained. Registration of a word as an input candidate and registration of the situation information associated with the input candidate may be previously performed by the user, or automatically performed at the time of input of the predetermined word. Specifically, holding the word which is previously associated with a type of the sensor, and comparing, by the registration section 111, these words and the character string (word) input by the user, it is decided whether the character string can be associated with the situation information and be registered. Hereinafter, the above configuration is explained in detail.

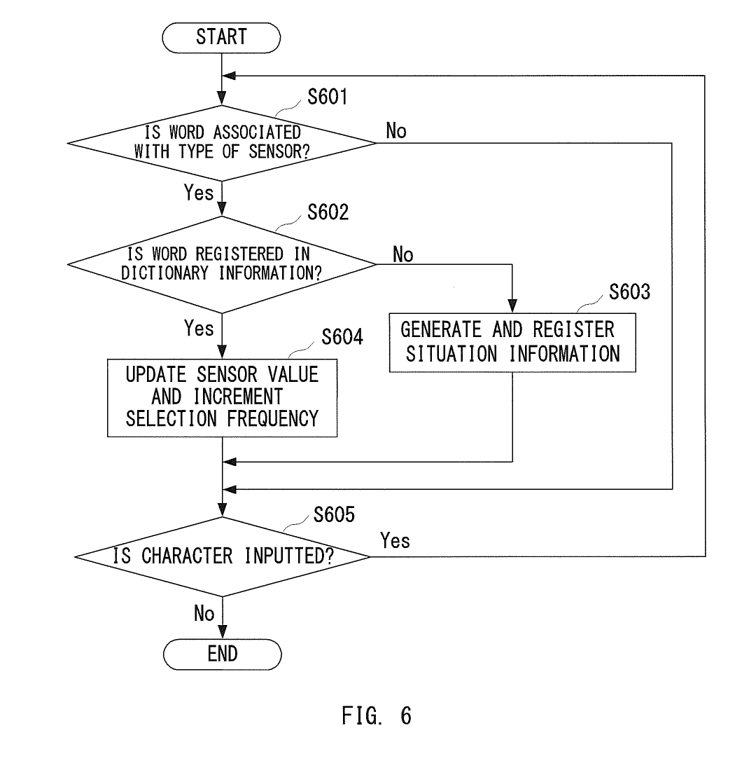

FIG. 6 is a flowchart illustrating a processing procedure for associating the input character strings with the detection result of a sensor and registering the input character. Suppose that the words respectively associated with the types of the sensor are previously stored in the state allowable to be referred in DB (database) which is not illustrated.

In response to the receipt of input character(s) from the user, Registration section 111, which is a functional section of the CPU 107, decides whether the received character string is the word associated with the type of the sensor or not by referring to DB which is not illustrated (S601). When the received character string is the word associated with a type of sensor (S601: Yes), it is decided whether the word is registered in the dictionary information stored in the memory storage 103 or not (S602). If not (S601: No), the process waits for the next character input by the user (S605).

When it is decided that the word has not been registered (S602: No), the registration section 111, which is a functional section of the CPU 107, registers the input characters as an input candidate, with the input candidate being associated with the generated situation information, in the dictionary stored in the memory storage 103 (S603). The situation information in this case is generated with its selection frequency as “1”, in this case, the sensor type associated with the word is treated as the sensor type of the situation information. Further, the detection result of the sensor 102 at the time of receiving the character input is treated as the sensor value of the situation information.

When the word is decided to have been registered in the dictionary (S602: Yes), the sensor value of the situation information of the input candidate corresponding to the received character string is updated with the detection result of the sensor 102 at the time of receiving the character input. Further, the selection frequency of the situation information is incremented by 1 (S604). The update of the sensor value may be achieved by simply overwriting the registered detection result, or by additionally registering the current detection result as a new sensor value independent from the already registered sensor value(s). Further, it is possible to calculate the average value of the current detection result and registered detection results and to register the average value. In addition, it is possible to update only the minimum value and maximum value of the detection results. When performing additional registration, it is desirable to control the process to delete oldest detection result at the time of deletion based on the use date and time or the order of registration. Thereby, the storage capacity of the dictionary occupying the memory storage 103 will be reduced.

The CPU 107 waits for the next character input (S605), and upon receiving the next character from the user (S605: Yes), return to the process of step S601. When it is decided that the character input has been completed (S605: No), this process is ended. Thus, a new input candidate can be automatically registered in the dictionary of the memory storage 103, without troubling the user.

In addition, when the received character string is the word associated with a sensor type, even if the word has been registered in the dictionary, the selection frequency corresponding to the character string is incremented by 1. Thereby, according to the frequency of the input by a user, it is possible to control the process by selectively deciding higher rank candidate to be selected. Further, by determine a threshold, It is also possible to control the process for deciding whether the sensor value of the situation information should be updated, instead of based on the detection result of the sensor at the time of input of a character all the time, based on the threshold. In addition, it is possible to store the sensor value suitable for the input candidate DB, obtain the same if needed. Further, upon registering the received character string as an input candidate with the input candidate being associated with the situation information in the dictionary of memory storage 103, it is possible to register the threshold, too.

In addition to the aforementioned method for dictionary registration, in case where the received character string is the word associated with a type of the sensor, it is possible to allow the user to decide whether the word should be registered in the dictionary as an input candidate or not. In addition, it is also possible to allow the user to register a dictionary as required, by running an application software for dictionary registration. Deletion of an input candidate registered in the dictionary may be performed as in the case of dictionary registration.

The dictionary may be used by only one user, or may be shared by two or more users. As illustrated in FIG. 1, the dictionary may be stored in the memory storage 103 installed in the inside of the information processing apparatus 101. Further, it is possible to use the dictionary on a network by the communication function (communications department 105) of the information processing apparatus 101. In that case, the information processing apparatus 100 obtains and uses the input candidate determined by the prediction section 114 provided with the dictionary on the network. Thereby, the load concerning communication and a prediction process can be reduced.

When the received character string is the word associated for a type of a sensor type, it is possible to employ a constitution in which the character string is decided to be directed to the present things, or to be directed to the past things. In this case, upon deciding that the character string is directed to the present things, the sensor value is updated to the newest information based on the detection result. Therefore, as to the word to be stored in the DB, an identifier which indicates that the word is directed to the present things or past things given.

On the other hand, the above constitution may be applied to when quoting a text which is drafted in the past, resuming edit of the text which it was in the middle of edit, it can apply. For example, when the situation information is associated with the character string in a text, it is decided whether it is necessary to change the character string based on the current detection result of the corresponding sensor 102, and the sensor value currently recorded in the situation information. When decided that the change is necessary, the input candidate which is suited for the current situation is preferentially displayed.

According to the information processing apparatus 101 of the present embodiment, the input candidate which is suited for the situation at the time of user's character input can be preferentially displayed in this way. Thereby, the user can efficiently perform drafting of an e-mail document, an input of a search string etc., for example.

### Second Embodiment

In the present embodiment, the following description is made for an information processing apparatus in which a word following the character string which has been settled may be predicted and represented as an input candidate. In the following description, the same numerical reference is applied to the element identical to or corresponding to the element described in the first embodiment.

By predicting the word which follows the settled character string input, only the input candidate which is suited to the situation at the time of user's character input based on the situation information to which the input candidate is related. Therefore, it is possible to reduce burden for the user in inputting character input, while increasing a level of convenience.

Further, in the information processing apparatus of the present embodiment, in the dictionary, an input candidate's prediction is performed based on the input settled word in a dictionary, under the control of the CPU 107. In the registration section 111, the combinations of words and the sensor value of the situation information associated with the word etc., are registered.

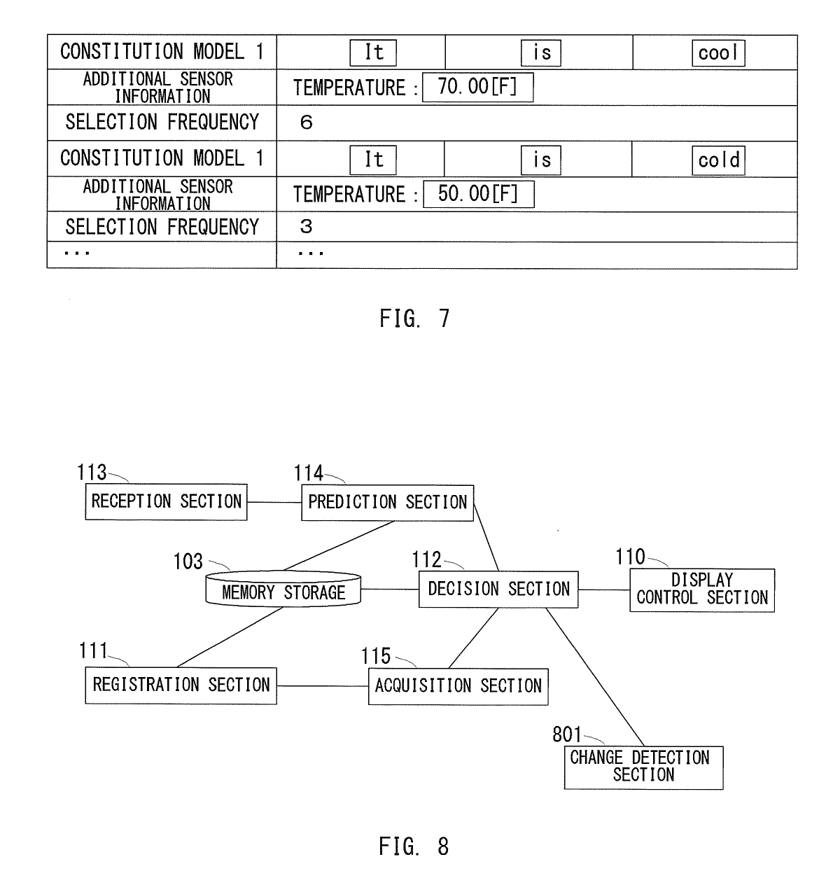

FIG. 7 is a diagram illustrating a dictionary table illustrating dictionary table including situation information of the present embodiment. The dictionary table shown in FIG. 7 has each item of a constitution model, additional sensor information, and a selection frequency.

Hereinafter, the process procedure for this case is explained with reference to the flow charts illustrated in FIGS. 2 and 3.

In the dictionary table illustrated in FIG. 7, the constitution model 1 is registered as a combination of the word “It”, “is”, and “cool” as a combination of the word, and the constitution model 2 is registered as a combination of “It”, “is”, and “cold”. In each constitution model, the additional sensor information and selection frequencies which are situation information are also related and registered.

In constitution model 1, the sensor type is “temperature (sensor)” and the sensor value is “70.00 [F]”. In constitution model 2, the sensor type is “temperature (sensor)” and the sensor value is “50.00 [F]”. Further, the selection frequency of the constitution model 1 is “6” times, and the selection frequency of the constitution model 2 is “3” times.

For example, the input candidate “cool” or “the input candidate “cold” is represented according to the detection result of the temperature sensor at the time of settling the character string “It is” input by the user. Therefore, the input candidate “cool” or “cold” is controlled to be presented regardless of a selection frequency, but according to the situation of the temperature at the time of the input of the character string “It is” is settled, for example. At this time, the input candidates (for example, “sunny”, “cloudy”, “rainy”, “dry”, etc.) which are not associated with the detection result of the temperature sensor may also be represented. Hereinafter, the process procedure for this case is explained with reference to the flow charts illustrated in FIGS. 2 and 3.

Here, suppose that input of the character string “It is”, which is input by the user under the situation of the ambient temperature (temperature) 65 [F], has been settled. Further, suppose that the sensor 102 of the information processing apparatus 101 is a temperature sensor.

In the process of step S201 illustrated in FIG. 2, the word having high possibility in following the settled input candidate is obtained from the dictionary of the memory storage 103. Suppose that the two input candidates “cool” and “cold” have been obtained for the settled input character string “It is”.

In the process of step 202, it is decided that two or more input candidates are obtained. Then, in the process of step S204, it is decided that whether there is an input candidate which is associated with the situation information among the obtained input candidate or not. As illustrated in FIG. 7, the input candidates “cool” and “cold” are associated with the situation information. Therefore, the process goes to the process of step S205. In the process of step S205, it is decided that the information processing apparatus 101 has a temperature sensor. Then, process goes to step S206, and the degree of similarity of the situation is decided.

In the present embodiment, in step S301 illustrated in FIG. 3, the detection result of the temperature sensor is obtained for deciding whether the situations are identical or not. Here, suppose that the detection result of the temperature sensor is 65 [F].

The threshold corresponding to the temperature sensor is obtained in the process of step S302. Here, the threshold is 6 [F].

In the process of step S303, two input candidates “cool” and “cold” are specified. Therefore, as to the number N of the input candidates in step 304, it is held as N=2.

In the process of step S305, the difference of the temperature (50.00) which is a sensor value of “cold” of the input candidate with N=2, and the temperature (65.00) which is the present detection result of the temperature sensor obtained by the process of step S301 is calculated. As a result, the difference 15 [F] is obtained.

In the process of step S306, it is decided that whether the obtained difference is less than or equal to a threshold. Since the threshold is 6 [F] and the difference is 15 [F], it is decided that the situations are not identical. Then, the process goes to the process of step S309, the number N (=2) of the input candidates is decremented by 1, therefore, N=1.

In the process of step S310, since the number of input candidates N is 1 (N=1), the process returns to the process of step S305, and the difference for the next input candidate is calculated.

In the process of step S305, the difference of the temperature (70.00) which is a sensor value of “cool” of the input candidate with N=1, and the temperature (65.00) which is the present detection result of the temperature sensor obtained by the process of step S301 is calculated. As a result, the difference 5 [F] is obtained.

In the process of step S306, it is decided that whether the obtained difference is less than or equal to a threshold. Since the threshold is 6 [F] and the obtained difference is 5 [F], it is decided that the situations are identical, and the decision result is held. Then, the process goes to the process of step S309, the number N (=1) of the input candidates is decremented by 1, therefore, N=0, and the process goes to the process of step S311. In the process of step S311, the decision result, which shows that the input candidate “cool” is in an identical situation and the input candidate “cold” is not in an identical situation, is outputted.

The process returns to the process of step S206 illustrated in FIG. 2, and it is decided that there is an input candidate which represents identical situation in the process of the following step S207, and the input candidate “cool” is given priority in displaying in the process of step S209. Then, the process waits for the next character input by the user in the process of step S210. In the vocabulary concerning temperature, it is also controllable to display only “cool” as an input candidate.

### Third Embodiment

In the present embodiment, following description is made for an information processing apparatus which can decide whether the input candidate which has already been represented to the user should be changed or not in case where the user's situation changes while representing the input candidate. In the following description, the same numerical reference is applied to the element identical to or corresponding to the element described in the first and second embodiments.

FIG. 8 is a schematic diagram for exemplifying a functional configuration of an information processing apparatus of the present embodiment. In the present invention, a change detection section 801 is provided, and that is the difference between the present invention and the first and second embodiments.

The change detection section 801 detects a change of the situation detected by sensor 102, and regards it as a change of a user's situation. Specifically, the change detection section 801 compares two detection results, i.e., the detection result (the present detection result) detected, while the input candidate is represented, by the sensor 102 and the detection result (the past detection result) which have been obtained in the process of step S206 indicated in FIG. 2. As a result of the comparison, when there is a change which exceeds a predetermined value, it is decided that the user's situation has been changed. When the user is at the situation where he is waiting a train and is not moving at the time of starting an input, and during the input of a word, he gets on a train and moves by train, it is decided that the situation of the user is changed.

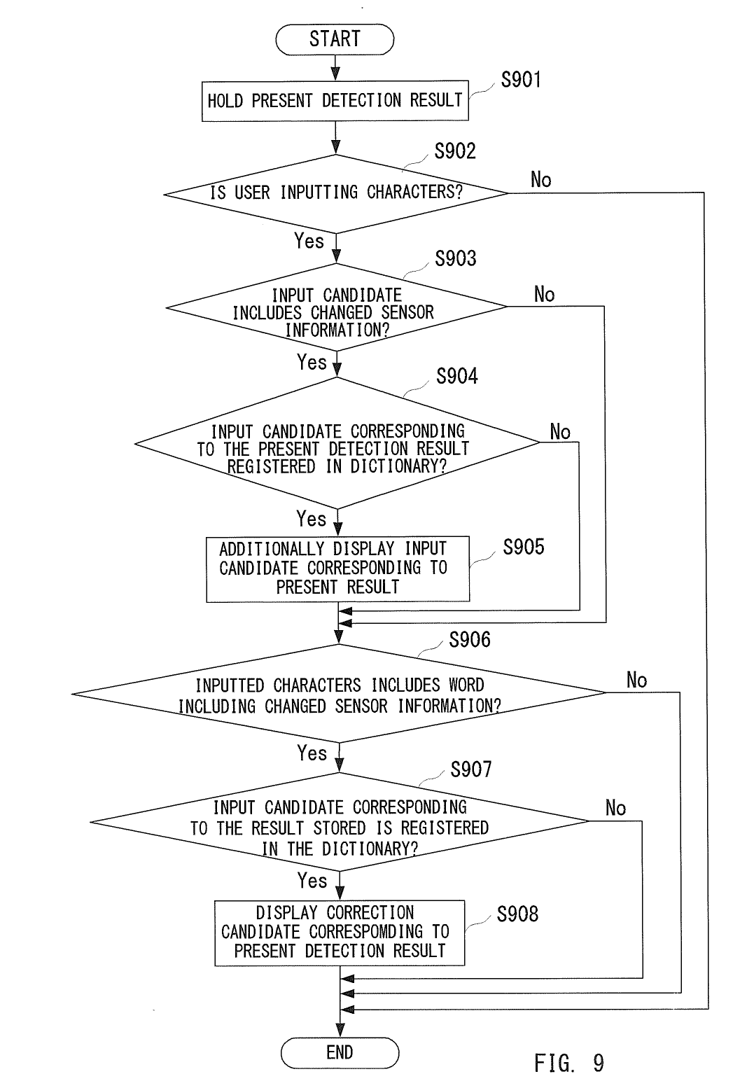

FIG. 9 is a flowchart illustrating an exemplifying processing procedure in additionally displaying an input candidate in response to a change of a user situation when the change has occurred. In the present embodiment, the process according to the flow chart of FIG. 2 is performed in the first embodiment or the second embodiment, and when the process reached to step S210, the acquisition section 115 obtains the detection result of the sensor 102 again as situation information. Then, the change detection section 801 compares the detection result of the sensor 102 to the situation information used in step S206. When two pieces of the situation information differs each other, the processes shown in the flow chart of FIG. 9 is started. Alternatively, the change detection section 801 may decide, regardless of the progress of the main process shown in the flow chart of FIG. 2, whether a change is occurred as compared to the last detection result at a predetermined cycle. When a change is detected, the change detection section 801 may start the processes shown in the flow chart of FIG. 9. However, in that case, it is necessary that the input candidate have been represented at the process of step S209 or step S208.

In response to a detection, by the change detection section 801, of a change of the user's situation, the decision section 112, which is a functional section of the CPU 107, obtains the detection result of the sensor 102 and holds the obtained detection result as the present situation (S901). The detection result to be obtained is a detection result at the time of detecting a change of user's situation.

The reception section 113, which is a functional section of the CPU 107, decides whether it is the situation where the user is inputting characters (S902). This decision is made by detecting a character input of the user. Alternatively, this decision is made by detecting whether the application software required for character inputs or not, or by detecting whether a key pad required for character inputs or not, etc.

The decision section 112, which is a functional section of the CPU 107, ends a series of processes when it is decided that no character input is performed in the situation (S902: No). Otherwise (S902: Yes), it is decided whether the input candidate corresponding to the sensor (for example, acceleration sensor) which has a detection result found, by a change detection section 801, to be changed is included in the input candidates which have been represented to the user by this point or not (S903). For example, “will ride” and “have ridden” are input candidates which have a common sensor type (each of candidates are derived from an identical verb and has a different tense). However, there is a case where the input candidate “will ride” is suitable for the user's situation at the start of input, however, at the present time, an input candidate “have ridden” is suitable, in place of “will ride”, for the user's situation.

When it is decided that the corresponding input candidate is included (S903: Yes), the decision section 112, which is a functional section of the CPU 107, decides whether the input candidate corresponding to the detection result held in the process of step S901 is registered in the memory storage 103 or not (S904). When it is decided that there is an input candidate corresponding to the stored detection result, i.e., when it is decided that there is an input candidate which is more suitable for the user's current situation (S904: Yes), the input candidate is additionally displayed by the display control section 110, which is a functional section of the CPU 107 (S905). Otherwise (S904: No), the process goes to the process of step S906.

The decision section 112, which is a functional section of the CPU 107, decides whether the character string which is an input candidate corresponding to the sensor which has a detection result found, by the change detection section 801, to be changed is included in the settled input character string (S906). When it is decided that the corresponding character string is included (S906: Yes), it is decided that whether an input candidate corresponding to the detection result stored by the process of step S901 is registered in the dictionary or not (S907). When it is decided that there is no input candidate corresponding to the stored detection result (S907: No), a series of processes is ended. When it is decided that there is an input candidate corresponding to the stored detection result (S907: Yes), the display control section 110 controls the display to additionally display the input candidate on the screen 500 as a correction candidate (S908). Otherwise (S907: No), a series of processes is ended.

In this embodiment, user may arbitrarily designate whether the settled input character string should be replaced with the correction candidate or not.

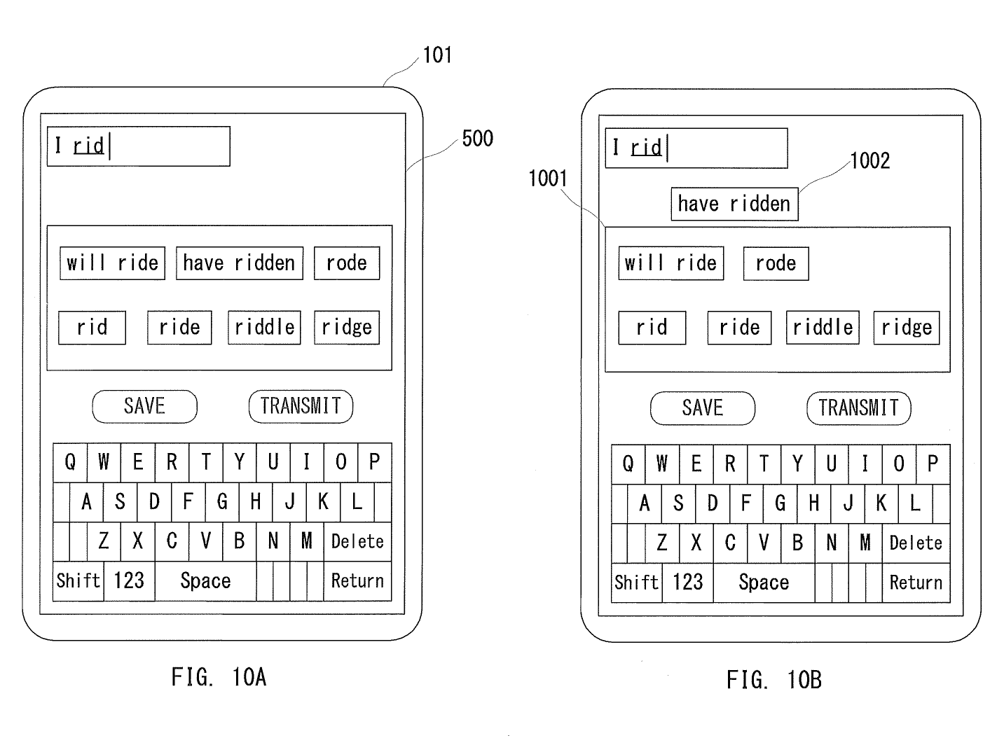

Referring to FIG. 10, the screen in which the input candidate is additionally displayed in step S905.

In the screen 500, the displayed contents are identical to the contents which have already been explained with reference to FIG. 5. In FIG. 10A, the input candidates including “rid”, “ride” and “will ride” are displayed in response to the character input “rid” by the user drafting an e-mail. In this case, the sensor 102 of the information processing apparatus 101 is an acceleration sensor.

FIG. 10B illustrates an example of screen 500 in which the additional input candidate is displayed. As shown in FIG. 10B, the input candidate “will ride” 1001 corresponding to the detection result of the sensor which is specified by the change detection section 801 is included in the input candidates represented. Therefore, a search for deciding whether the input candidate corresponding to the stored detection result, i.e., the candidate which is more suitable for the present situation, is registered in the dictionary or not. As shown in FIG. 10B, the specified input candidate “have ridden” 1002 is additionally displayed as a result of the search.

Further, as shown in FIG. 10B, when there is an input candidate which is more suitable for the present situation, the process is controlled such that the character string “will ride” 1001 is displayed inverted (or highlighted). Thereby, the user can easily understand the correspondence relation between the input character and the additionally displayed input candidate.

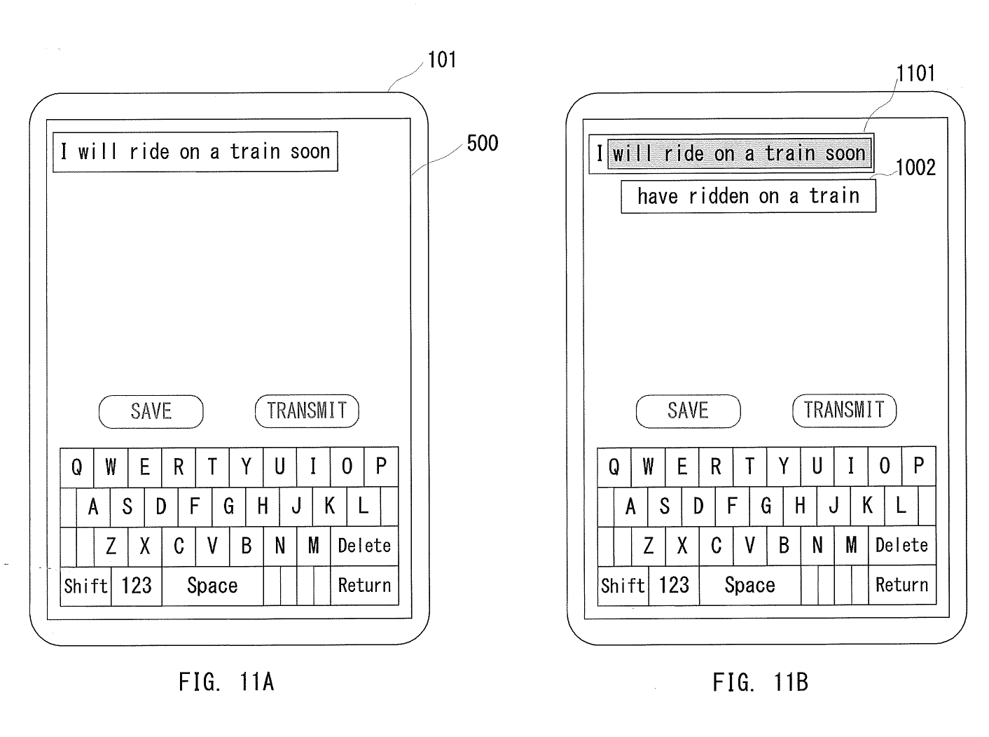

Referring to FIG. 11, the screen in which the corrected candidate is displayed in step S908.

Screen 500 illustrated in FIG. 11A is the example of a screen before displaying the correction candidate. FIG. 11A, illustrates that the character string “I will ride on a train soon” input by the user has been settled.

FIG. 11B illustrates an example of screen 500 when the corrected input candidate is displayed. As shown in FIG. 10B, the character string “will ride” corresponding to the detection result of the sensor which is specified by the change detection section 801 is included in the settled character string. Therefore, a search for deciding whether the input candidate corresponding to the stored detection result, i.e., the candidate which is more suitable for the present situation, is registered in the dictionary or not. As shown in FIG. 11B, as a result of the search, the specified input candidate is additionally displayed as a corrected candidate “have ridden on a train” 1102. At this time, when tense is changed, the words and phrases (for example, “soon”) which generates semantic inconsistency may also be included in the portion to be changed.

Further, as shown in FIG. 11B, when there is an corrected candidate which is more suitable for the present situation, the process is controlled such that the character string “will ride on a train soon” 1101 is displayed inverted (or highlighted). Thereby, the user can easily understand the correspondence relation between the input character and the additionally displayed input candidate.

Further, it is decided that whether the user is in a situation where the input is interrupted, based on the detection results of an acceleration sensor or a proximity sensor etc. For example, the above situation may be a situation in which the user is trying to pass the information processing apparatus 101, which is a smart phone, for example, from the right hand to the left hand. In response to the detection, by the change detection sections 801, of the change of user's situation, the detection result of all the sensors of the information processing apparatus 101 at that time is obtained, and the obtained detection results are stored. Then, in response to the restart of an input, the detection result of all the sensors is again obtained, and, for the sensor for which the detection result is found to be changed, the processes of step S903 and step S906 are performed.

Thereby, it is possible to represent the input candidate and/or the corrected candidate which are more suitably reflecting the change of the user's situation.

As described above, according to the information processing apparatus of the present embodiment, when the situation under which the user performs input of character strings has been changed, it is possible to represent new input candidate for the input candidate which has been represented. Further, it is possible to represent a corrected candidate for changing input contents for the input character string which has been settled. Thereby, even if the user's situation has been changed, it is possible to change or correct the input contents. Therefore, convenience for the user is improved.

The embodiments as described above are to particularly describe the present invention. The scope of the present invention is not limited to these embodiments.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of priority from Japanese Patent Application No. 2013-176289, filed Aug. 28, 2013, which is hereby incorporated by reference herein in its entirety.

What is claimed is:

1. An information processing apparatus for representing at least one candidate for a character string to be input based on at least one input character, comprising:
an acquisition unit configured to obtain situation information which represents the situation in which the information processing apparatus exists based on the information detected by the at least one sensor;
a prediction unit configured to predict at least one character string to be input based on the at least one character input by a user operation;
a storage unit configured to store two or more character strings with each of the two or more character strings being associated with situation information which represents the situation in which the character string is used; and
a representation unit configured to represent at least one character string predicted by the prediction unit,
wherein, when the at least one predicted character string includes at least one of the character string stored in the storage unit, the representation unit preferentially display the character string associated with the situation information which is similar to that obtained by the acquisition unit.

2. The information processing apparatus according to claim 1,
wherein, when at least one character is input by the user, the type of the at least one sensor which detects the information representing the situation in which the information processing apparatus exists and a predetermined value of the information detected by the sensor are registered in the storage unit as the situation information which represents the situation in which the character string is used.

3. The information processing apparatus according to claim 2, further comprising:
a display unit including a screen;
a receiving unit configured to receive a designation of a character string among the character strings, which are the candidates, displayed on the screen; and
a registration unit configured to update the information stored in the storage unit, in response to the receipt of the designation, based on the detection result of the sensor of the type represented by the situation information of the designated character string.

4. The information processing apparatus according to claim 3,
wherein the registration unit generates, when the at least one input character is a character string related to the information which represents the type of the sensor and when the character string is not registered in the storage unit with the character string being associated with the situation information, situation information which includes the type of the sensor corresponding to the character string and the result of the sensor as the sensor value, associates the generated situation information and the character strings and registers the generated situation information in the storage unit.

5. The information processing apparatus according to claim 2,
wherein the sensor detects, upon receiving the character input, acceleration acting on the information processing apparatus as information which represents the situation in which the information processing apparatus exists, and
wherein information which represents transition of acceleration is registered, as the situation information which represents the situation in which the character string is used, in the storage unit, and
further comprising a decision unit configured to decide whether a first situation and a second situation are similar or not, the first situation is a situation which is represented by transition of the acceleration in the situation information and the second situation is a situation represented by transition of the acceleration detected by the sensor.

6. The information processing apparatus according to claim 2,
wherein the sensor detects, upon receiving the character input, the position of the information processing apparatus as information which represents the situation in which the information processing apparatus exists, and
wherein information which represents the position is registered, as the situation information which represents the situation in which the character string is used, in the storage unit, and
further comprising a decision unit configured to decide whether the position represented by the situation information and the position detected by the sensor are similar or not, based on the difference between the position.

7. The information processing apparatus according to claim 2,
wherein, upon receiving the character input, the sensor detects at least one of:
the direction representing the direction of the information processing apparatus; the temperature of the space in which the information processing apparatus exists; and
the atmospheric pressure acting on the information processing apparatus as information which represents the situation in which the information processing apparatus exists, and
wherein at least one of the information selected from the group consisting of direction, temperature and atmospheric pressure is registered, with the type of the sensor, in the storage unit as the situation information which represents the situation in which the character string is used,
wherein the decision unit calculates the difference between
1) one of the direction, the temperature and the atmospheric pressure represented by the situation information or combination thereof and
2) the detection result detected by the corresponding sensor,
and decides, based on the calculated result, whether the situation at the time of receiving the character input and the situation associated with the character string predicted by the prediction unit are similar or not.

8. The information processing apparatus according to claim 7, wherein the decision unit decides, by comparing the calculated result and a threshold which is determined for each of the type of the sensor, a degree of similarity.

9. The information processing apparatus according to claim 2, wherein the sensors are a plurality of sensors each having different type,
wherein the sensor values each corresponding to the type of the sensor is registered, as the situation information which represents the situation in which the character string is used, in the storage unit,
wherein the decision unit calculates, when the sensor of the type represented by the situation information is provided in the information processing apparatus, the difference between 1) the sensor value represented by the situation information and 2) the detection result of the sensor of the type represented by the situation information, and decides, based on the calculated result, whether the situation at the time of receiving the character input and the situation associated with the character string predicted by the prediction unit are similar or not.

10. The information processing apparatus according to claim 1, further comprising:
a display control unit configured to control, when at least one character string corresponding to the at least one input character string is displayed on a screen, the display for deciding whether the character string is to be displayed or not according to the degree of similarity decided by the decision unit.

11. The information processing apparatus according to claim 10, wherein the display control unit controls, when the number of the character strings are restricted, to display the character strings as input candidates to be ordered by the decreasing degree of similarity within the range of the restriction.

12. The information processing apparatus according to claim 1,
further comprising a change detection unit configured to detect a change, as compared to the situation at the time of representing the character string, of situation in which the information processing apparatus exist,
wherein the display control unit controls to further display the character string which corresponds to the situation after the change has been detected by the change detection unit, as the candidate, on the screen.

13. An information processing method executed by an information processing apparatus for representing at least one candidate for a character string to be input based on at least one input character, comprising:
obtaining situation information which represents the situation in which the information processing apparatus exists based on the information detected by the at least one sensor;
predicting at least one character string to be input based on the at least one character input by a user operation;
storing two or more character strings with each of the two or more character strings being associated with situation information which represents the situation in which the character string is used; and
representing the predicted at least one character string, wherein, when the at least one predicted character string includes at least one of the stored character string, the character string associated with the situation information which is similar to that obtained by the acquisition unit is preferentially displayed.

14. A non-transitory computer readable storage medium storing computer executable instructions for causing a computer to execute a method comprising:
obtaining situation information which represents the situation in which the information processing apparatus exists based on the information detected by the at least one sensor;
predicting at least one character string to be input based on the at least one character input by a user operation;
storing two or more character strings with each of the two or more character strings being associated with situation information which represents the situation in which the character string is used; and
representing the predicted at least one character string, wherein, when the at least one predicted character string includes at least one of the stored character string, the character string associated with the situation information which is similar to that obtained by the acquisition unit is preferentially displayed.
